(19) United States
(12) Patent Application Publication
(10) Pub. No.: US 2013/0199636 A1
(43) Pub. Date: Aug. 8, 2013

(54) CHECK VALVE OF BRAKE SYSTEM

(71) Applicant: Mando Corporation, Pyeongtaek-si (KR)

(72) Inventor: Yoon-Ho Doh, Pyeongtaek-si (KR)

(73) Assignee: MANDO CORPORATION, Pyeongtaek-si (KR)

(21) Appl. No.: 13/757,546

(22) Filed: Feb. 1, 2013

(30) Foreign Application Priority Data
Feb. 2, 2012 (KR) 10-2012-0010674

(51) Int. Cl. F16K 15/04

(52) U.S. Cl. CPC F16K 15/044
USPC 137/539

(57) ABSTRACT

Disclosed herein is a check valve of a brake system to enable easy processing and assembly through a simplified structure. The check valve for brake systems includes a valve sheet housing press-fitted to a step of a hydraulic block provided with an oil passage, the valve sheet housing including an upper part having an opening and a lower part having an open/close hole to form an oil channel in an inner part, a ball provided in the valve sheet housing to open or close the oil channel, and a spring to elastically support the ball, wherein the valve sheet housing is provided in the upper part thereof with a plurality of fixing protrusions that protrude in an inside diameter direction along a circumference of the opening to support the spring.

### CROSS-REFERENCE TO RELATED APPLICATION(S)

This application claims the benefit of Korean Patent Application No. 2012-0010674, filed on Feb. 2, 2012 in the Korean Intellectual Property Office, the disclosure of which is incorporated herein by reference.

### BACKGROUND

1. Field

Embodiments of the present invention relate to a check valve of a brake system to enable easy processing and assembly through a simplified structure.

2. Description of the Related Art

Brake systems for braking are necessarily mounted in vehicles. In recent years, a variety of systems to obtain stronger and more stable braking force have been suggested. Examples of brake systems include anti-lock brake systems (ABSs) to prevent slipping of wheels during braking, brake traction control systems (BTCSs) to prevent slipping of driving wheels during sudden acceleration of vehicles, and vehicle dynamic control systems (VDCs) to stably maintain a driving state of vehicles by controlling a brake hydraulic pressure through a combination of an anti-lock brake system with a brake traction control system.

These electronically-controlled brake systems include a plurality of solenoid valves to control a brake hydraulic pressure transported the hydraulic brake mounted on the wheel of vehicles, a pair of a low-pressure accumulator and a high-pressure accumulator to temporarily store oil escaped from the hydraulic brake, a motor and a pump to forcibly pump the oil of the low-pressure accumulator, a plurality of check valves to prevent reverse flow of the oil, and ECU to control driving of the solenoid valve and the motor. These components are compactly present in hydraulic blocks made of aluminum.

FIG. 1 is a sectional view illustrating a check valve used for a conventional electronically-controlled brake system. For example, the check valve mounted in a passage between a suction part of the pump and the low-pressure accumulator prevents transfer of oil from a master cylinder to the low-pressure accumulator and prevents transfer of oil from a wheel cylinder to the suction part of the pump during operation of the pump by motor driving.

As shown in FIG. 1, the check valve 1 includes a valve housing 3 press-fitted to a hydraulic block 2 provided with an oil channel 2a, a ball 4 to open or close an inner oil passage 3a provided in the valve housing 3, a spring 5 to elastically support the ball 4 toward the oil passage 3a, and a spring sheet 6 assembled with the valve housing 3 to guide the spring 5.

However, the conventional check valve 1 has a complicated appearance and is difficult to assemble since it is manufactured with functionality alone in mind. In particular, as shown in FIG. 1, the valve housing 2 has a disadvantage of high manufacturing cost since it has a complicated shape and a large product size and can be manufactured only by cutting. The conventional check valve 1 has a disadvantage of many components and low assembly reliability for a long period, since it has a structure in which the spring sheet 6 is press-fitted to the valve housing 3.

### SUMMARY

Therefore, it is an aspect of the present invention to provide a check valve of a brake system to enable easy manufacture and assembly through a simplified structure and thereby reduce manufacturing costs.

Additional aspects of the invention will be set forth in part in the description which follows and, in part, will be obvious from the description, or may be learned by practice of the invention.

In accordance with one aspect of the present invention, a check valve for brake systems includes: a valve sheet housing press-fitted to a step of a hydraulic block provided with an oil passage, the valve sheet housing including an upper part having an opening and a lower part having an open/close hole to form an oil channel in an inner part; a ball provided in the valve sheet housing to open or close the oil channel; and a spring to elastically support the ball, wherein the valve sheet housing is provided in the upper part thereof with a plurality of fixing protrusions that protrude in an inside diameter direction along a circumference of the opening to support the spring.

The valve sheet housing may be manufactured by dip drawing.

The spring may be a tapered coil spring having one end to support the ball, and the other end corresponding to an inner diameter of the valve sheet housing and being supported by the fixing protrusions.

The fixing protrusions may be spaced from one another by a predetermined distance along the circumference of the valve sheet housing.

The fixing protrusions may be press-deformed to be inclined downward to fix the spring.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 illustrates a conventional check valve of a brake system;

FIG. 2 is a hydraulic circuit view illustrating a brake system using a check valve according to a preferred embodiment of the present invention;

FIG. 3 is an exploded perspective view illustrating a check valve of a brake system according to a preferred embodiment of the present invention;

FIG. 4 is an assembled sectional view of FIG. 3; and

FIG. 5 illustrates a state in which the check valve according to the preferred embodiment of the present invention is mounted on a hydraulic block of a brake system.

### DETAILED DESCRIPTION

Reference will now be made in detail to the embodiments of the present invention, examples of which are illustrated in the accompanying drawings, wherein like reference numerals refer to like elements throughout. The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method the inventor knows for carrying out the invention. Therefore, the configurations described in the embodiments and drawings of the present invention are merely most preferable embodiments but do not represent all of the technical spirit of the present invention. Thus, the present invention should be construed as including all the modifications, equivalents, and substitutions included in the spirit and scope of the present invention at the time of filing this application.

The present invention has a feature associated with configurations of check valves used for brake systems. Accordingly, prior to description of check valves of brake systems of preferred embodiments of the present invention, the brake systems using check valves of the present invention will be described in brief.

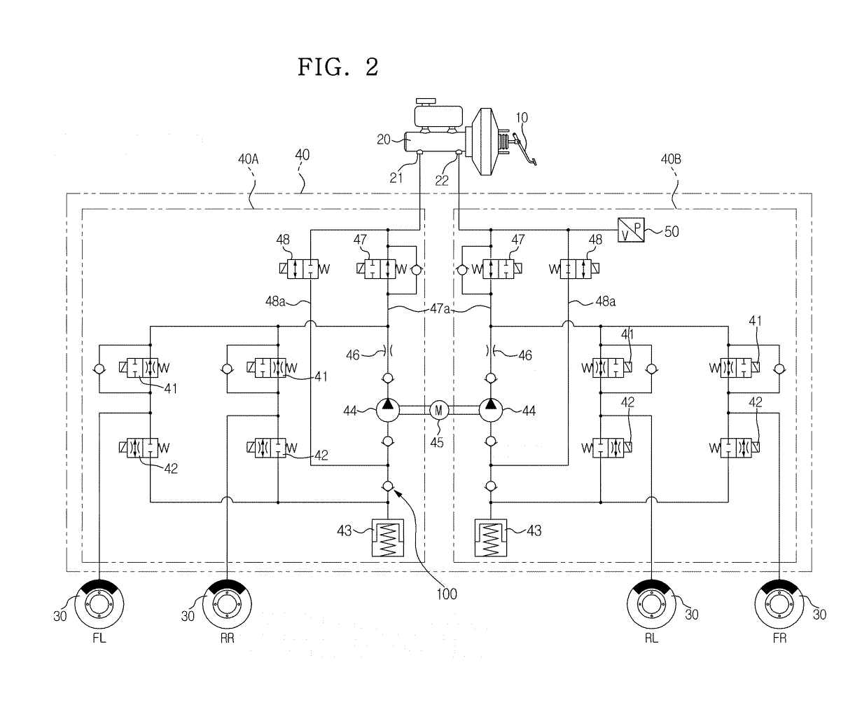

FIG. 2 is a hydraulic circuit view illustrating a brake system using a check valve according to a preferred embodiment of the present invention. The electronically-controlled brake system includes a brake pedal 10 to receive operating force of a driver, a brake booster 11 to double a pedal effort of the brake pedal 10 using difference in pressure between a vacuum pressure and atmospheric pressure based on the pedal effort of the brake pedal 10, a master cylinder 20 to generate a pressure through the brake booster 11, a first hydraulic circuit 40A to connect a first port 21 of the master cylinder 20 to two wheel brakes (or wheel cylinders) 30 and thereby control transfer of hydraulic pressure, a second hydraulic circuit 40B to connect the second port 22 of the master cylinder 20 to remaining two wheel brakes 30 and thereby control transfer of a hydraulic pressure. The first hydraulic circuit 40A and the second hydraulic circuit 40B are compactly mounted in the hydraulic block 40.

Each of the first hydraulic circuit 40A and the second hydraulic circuit 40B includes solenoid valves 41 and 42 to control brake hydraulic pressure transmitted to the two wheel brakes 30, a pump 44 to intake and pump an oil discharged from the wheel brake 30 or the master cylinder 20, a low-pressure accumulator 43 to temporarily store the oil discharged from the wheel brake 30, an orifice 46 to reduce a pressure pulse of a hydraulic pressure pumped from the pump 44, and an auxiliary passage 48a to guide the oil from the master cylinder 20 to an inlet of the pump 44.

The solenoid valves 41 and 42 are connected to upper and lower parts of the wheel brake 30 and are divided into a normal open solenoid valve 41 that is disposed in the upper part of each wheel brake 30 and opens in a normal state and a normal close solenoid valve 42 that is disposed in the lower part of each wheel brake 30 and closes in a normal state. Open/close operation of these solenoid valves 41 and 42 is controlled by an electronic control unit (ECU; not shown) that senses a vehicle speed using a wheel speed sensor disposed in each wheel, and the oil discharged from the wheel brake 30 when the normal close solenoid valve 42 opens upon braking at a reduced pressure is temporarily stored in the low-pressure accumulator 43.

The pump 44 is driven by the motor 45 and intakes the oil stored in the low-pressure accumulator 43, ejects the same to the orifice 46 and thereby transfers hydraulic pressure to the wheel brake 30 or the master cylinder 20.

In addition, a normal open solenoid valve 47 (hereinafter, referred to a “TC valve”) for a traction control system (TCS) is mounted on a main passage 47a to connect the master cylinder 20 to an outlet of the pump 44. This TC valve 47 usually maintains an open state to transfer a brake hydraulic pressure formed in the master cylinder 20 during general braking using the brake pedal 10 through the main passage 47a to the wheel brake 30.

In addition, the auxiliary passage 48a branches from the main passage 47a and guides oil from the master cylinder 20 to an inlet of the pump 44. The auxiliary passage 48a is provided with a shuttle valve 48 to enable the oil to flow to only the inlet of the pump 44. The electrically operating shuttle valve 48 is mounted in the middle of the auxiliary passage 48a and remains closed in a normal state and opens in a TCS mode.

In addition, the passage connected to the master cylinder 20 is provided with a pressure sensor 50 to sense braking pressure transferred to the TC valve 47 and the shuttle valve 48, and the pressure sensor 50 is electrically connected to the electronic control unit and is controlled thereby.

Although not illustrated, the brake booster 11 is provided with a pressure sensor to sense a vacuum pressure and an atmospheric pressure of the brake booster 11, or with a wheel pressure sensor to sense an actual brake pressure applied to front left and right (FL and FR) wheels and rear left and right (RL and RR) wheels. Like the pressure sensor 50 to sense a brake pressure transferred to the

TC valve 47 and the shuttle valve 48, these pressure sensors are electrically connected to the electronic control unit and are controlled thereby.

A braking operation of a hydraulic brake system for vehicles according to the present invention is as follows.

First, a driver works a brake pedal 10 to decelerate or keep stopping during driving or stopping. Accordingly, a double force higher than an input force is generated in the brake booster 11 and a considerable brake hydraulic pressure is generated in the master cylinder 20 through the double force. The generated brake hydraulic pressure is transferred through the solenoid valves 41 to the front right and left (FR and FL) wheels and the rear right and left (RR and RL) wheels to implement a braking operation. In addition, when the driver slowly or completely takes their foot off the brake pedal 10, an oil pressure in each wheel brake is returned to the master cylinder 20 through the solenoid valves 41 and 42, and a braking force is reduced or a braking operation is completely removed.

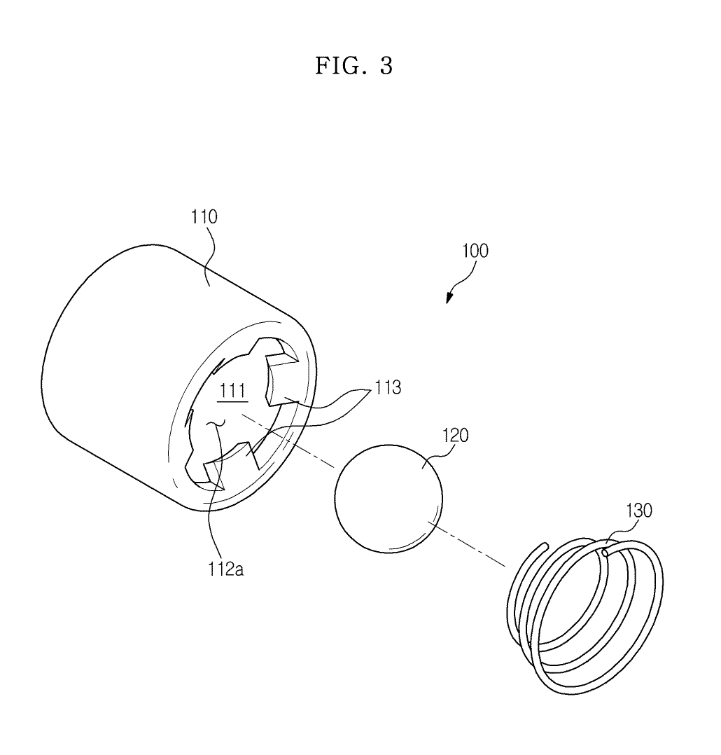

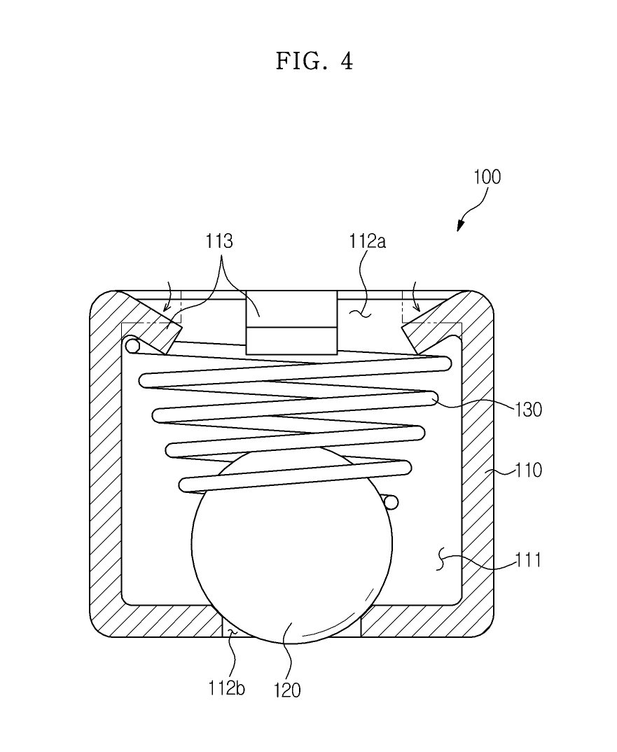

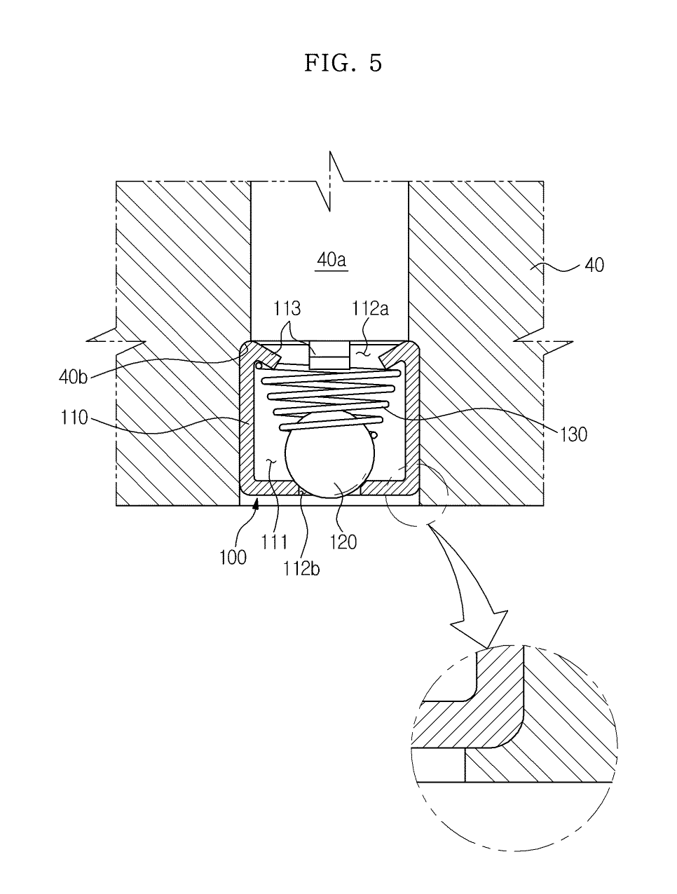

The check valve 100 according to the embodiment of the present invention prevents reverse flow of oil and is disposed at predetermined positions of the hydraulic circuits 40A and 40B. FIG. 3 is an exploded perspective view illustrating a check valve of a brake system according to a preferred embodiment of the present invention, FIG. 4 is an assembled sectional view of FIG. 3, and FIG. 5 illustrates a state in which the check valve is mounted on a hydraulic block of a brake system.

Referring to the drawings, the check valve 100 is press-fitted to the hydraulic block 40 and includes a valve sheet housing 110 having an inner part forming an oil channel 111, a ball 120 included in the valve sheet housing 110 to open or close the oil channel 111 and a spring 130 to electrically support the ball 120.

In this case, the hydraulic block 40 is provided with an oil passage 40a, enabling oil flow, and the oil passage 40a is provided with a step 40b having an increased diameter. That is, in this embodiment, the check valve 100 is press-fitted to the step 40b.

The valve sheet housing 110 is provided in an inner part thereof with an oil channel 111 and has a cylindrical cross-section. More specifically, the valve sheet housing 110 is provided in an upper part thereof with an opening 112a and in a lower part thereof with an open/close hole 112b to enable flow of oil through the oil channel 111. The opening 112a has the same diameter as the oil channel 111 and the open/close hole 112b has a smaller diameter than that of the oil channel 111.

Meanwhile, the valve sheet housing 110 is provided in an upper part thereof with a fixing protrusion 113 that protrudes in an inside diameter direction along a circumference of the opening 112a. The fixing protrusion 113 supports a spring 130 provided in an inner portion of the valve sheet housing 110. The fixing protrusion 113 will be described below again.

The inner portion, i.e., the oil channel 111 of the valve sheet housing 110, is provided with a ball 120 and the spring 130. The ball 120 contacts the open/close hole 112b through the spring 130 and closes the open/close hole 112b. The spring 130 is provided as a tapered coil spring having one end to support the ball, and the other end corresponding to an inner diameter of the valve sheet housing and being supported by the fixing protrusions 113. The oil channel 111 is closed by closing the open/close hole 112b. That is, open or close of the oil channel 111 are possible by pushing the oil channel 111 with a force higher than an elastic force of the spring 130 according to oil flow.

In order to selectively open or close the oil channel 111 according to oil flow, a structure to fix the spring 130 is provided. For example, the afore-mentioned fixing protrusion 113 is provided in the opening 112a of the valve sheet housing 110 to support the spring 130.

As shown in the drawings, the fixing protrusion 113 comprises a plurality of retaining productions 113 spaced from one another by a predetermined distance along the circumference of the valve sheet housing 110. Four fixing protrusions 113 disposed at an angle of 90 degrees from a central axis of the valve sheet housing 110 are illustrated, but embodiments of the present invention are not limited thereto. The number of the fixing protrusions 113 may be selectively changed so long as the spring 130 is stably supported to be not isolated from the valve sheet housing 110.

The spring 130 is stably fixed to the fixing protrusion 113 by mounting the ball 120 and the spring 130 on the valve sheet housing 110 and plastically deforming the fixing protrusion 113 by pressing the fixing protrusion 113 such that the fixing protrusion 113 is inclined downward. A pressing level of the spring 130 can be determined through plastic deformation of the fixing protrusion 113.

Further, the check valve 100 having the structure described above is pushed toward the step 40b such that a upper part of the check valve 100 is supported by the step 40b when press-fitted to the hydraulic block 40, the hydraulic block 40 is pressing-deformed using an assembly tool (not shown) such that the hydraulic block 40 surrounds a lower part of the check valve 100 as shown in the enlarged view of FIG. 5. As a result, the check valve 100 is stably fixed on the hydraulic block 40.

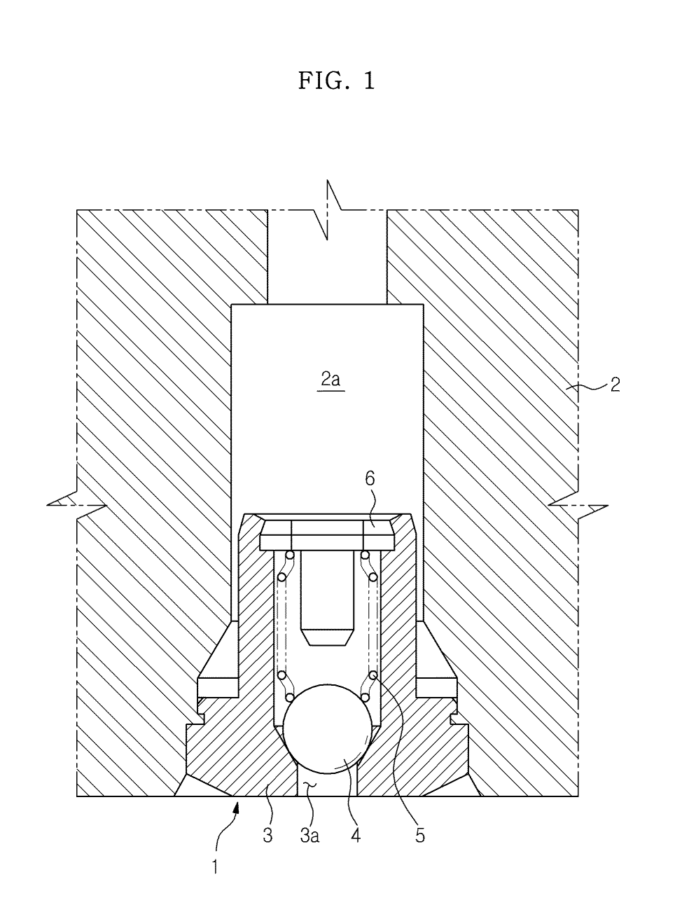

As a result, the check valve 100 according to the embodiment of the present invention has a simpler shape than that of a conventional check valve, thus being manufactured at a low cost using a dip drawing method such as pressing or forging. As a result, manufacturing costs are reduced and processability is thus improved. In addition, the valve sheet housing 110 reduces the number of components and decreases weight and size since it includes one component to perform the same functions of a conventional valve housing (reference numeral “3” of FIG. 1) and spring sheet (reference numeral “6” of FIG. 1), and is easy to assemble and has high production efficiency through a simplified configuration.

As is apparent from the above description, the embodiment of the present invention provides a check valve of a brake system that has decreased size and weight through a simple shape, reduces manufacturing costs and improves processability due to suitability for general pressing.

In addition, a fixing protrusion formed on the valve sheet housing according to the present invention performs the same function as a conventional spring sheet, thus advantageously having a simpler configuration than a conventional check value and reducing the number of components. Accordingly, the check valve is easy to assemble and is advantageous in terms of production efficiency.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A check valve for brake systems comprising:
a valve sheet housing press-fitted to a step of a hydraulic block provided with an oil passage, the valve sheet housing including an upper part having an opening and a lower part having an open/close hole to form an oil channel in an inner part;
a ball provided in the valve sheet housing to open or close the oil channel; and
a spring to elastically support the ball,
wherein the valve sheet housing is provided in the upper part thereof with a plurality of fixing protrusions that protrude in an inside diameter direction along a circumference of the opening to support the spring.

2. The check valve according to claim 1, wherein the valve sheet housing is manufactured by dip drawing.

3. The check valve according to claim 1, wherein the spring is a tapered coil spring having one end to support the ball, and the other end corresponding to an inner diameter of the valve sheet housing and being supported by the fixing protrusions.

4. The check valve according to claim 1, wherein the fixing protrusions are spaced from one another by a predetermined distance along the circumference of the valve sheet housing.

5. The check valve according to claim 1, wherein the fixing protrusions are press-deformed to be inclined downward to fix the spring.
